(19) United States
(12) Patent Application Publication
(10) Pub. No.: US 2026/0279711 A1
(43) Pub. Date: Sep. 17, 2026

(54) CONTACTOR

(71) Applicant: ABB Schweiz AG, Baden (CH)

(72) Inventors: Yoann Granier, Vienne (FR); Juan de Carlos Villellas, Madrid (ES)

(73) Assignee: ABB Schweiz AG, Baden (CH)

(21) Appl. No.: 19/566,281

(22) Filed: Mar. 13, 2026

(30) Foreign Application Priority Data
Mar. 14, 2025 (EP) 25163848.2

(51) Int. Cl. H01H 50/14

(52) U.S. Cl. CPC H01H 50/14

(57) ABSTRACT

A contactor includes at least a pair of screw connecting terminals, each having a fixed contact disposed in a ferrule cavity, the ferrule cavity having an opening defined between insulation walls. The opening includes a wide section and a narrow section that is narrower than the wide section. The wide section and the narrow section are configured to fit with different sizes of ferrules. The narrow section is wider than a pin of the ferrule, which size fits to the wide section, and the opening by the narrow section opens into the part of the ferrule cavity adjacent to the fixed contact, while the wide section is on the opposite side to the fixed contact.

### CROSS-REFERENCE TO RELATED APPLICATIONS

The instant application claims priority to European Patent Application No. EP25163848.2, filed March 14, 2025, which is incorporated herein in its entirety by reference.

### FIELD OF THE DISCLOSURE

The present disclosure generally relates to a contactor and, more particularly, to a screw terminal contactor.

### BACKGROUND OF THE INVENTION

Contactors are typically designed to accommodate specific types of ferrules, based on the structure of their terminal connections. The compatibility between a contactor and a ferrule is influenced by factors such as the type of terminal, its size, and the clamping mechanism used. The terminal type and clamping mechanism help determine the appropriate ferrule type, while the terminal size dictates the size of the ferrule that can be properly coupled to it.

Using a ferrule that is either too large or too small for a contactor can introduce several electrical and mechanical risks, potentially compromising the safety, durability, and reliability of the connection. A ferrule that is too thin or not properly matched to the terminal may fail to provide a secure electrical connection, leading to increased resistance, overheating, and possibly resulting in contactor failure. Ferrules of incorrect diameter can cause elevated electrical resistance, leading to overheating, insulation degradation, and, in extreme cases, fire hazards. Additionally, an oversized or poorly crimped ferrule can exert excessive pressure on the terminal, damaging the terminal screw or spring mechanism and resulting in a loose wire connection.

The present invention seeks to resolve the contradiction of terminal size versatility and safety of work by providing an improved solution.

### BRIEF SUMMARY OF THE INVENTION

The present disclosure generally describes an improved contactor solution that increases terminal size versatility while ensuring a secure and reliable attachment of the ferrule to the contactor.

According to an aspect of the present disclosure, there is provided a contactor with modular connection of the coil, comprising an insulating body, an operating coil housed in the insulating body, means of modular connection of the coil to an external circuit so that the coil may be powered, and at least a pair of screw connecting terminals, and each screw connecting terminals has a fixed contact in a ferrule cavity, and the ferrule cavity has an opening between an insulation walls, wherein the at least one opening comprises a wide section and a narrow section narrower than the wide section and the ferrule cavity, such that the wide section and the narrow section are configured to fit with different sizes of ferrules. The narrow section is wider than a pin of the ferrule which size fits to the wide section. The opening by the narrow section opens into the part of the ferrule cavity adjacent to the fixed contact, while the wide section is on the opposite side to the fixed contact.

Preferably a widths of the wide section and narrow section are mutually parallel and oriented such that they are perpendicular to a terminal screw of the screw connecting terminal.

Preferably the centers of the wide section and the narrow section widths are symmetrical with respect to the screw connecting terminal.

Preferably the ferrule cavity has a width equal to the width of the wide sections.

Preferably the inner part of the screw connecting terminal has a width equal to a width of the wide section.

Preferably the narrow section is formed by at least one additional protrusion extends from the insulation wall.

In one of the preferred embodiments the narrow section is formed by two additional protrusions extending from the insulation walls, mutually symmetrical in the screw connecting terminal arrangement.

### BRIEF DESCRIPTION OF THE SEVERAL VIEWS OF THE DRAWING(S)

FIG. 1 is a broken view of a contactor from a screw connecting terminal side, in accordance with the disclosure.

FIG. 2 is a partial top view of a contactor that includes additional protrusions located on insulation walls, in accordance with the disclosure.

FIG. 3 is an enlarged detail view of a ferrule cavity cross-section taken along line A-A in FIG. 7.

FIG. 4 is a partial exploded view of a method of inserting a tubular ring lug ferrule into a contactor, in accordance with the disclosure.

FIG. 5 is a partial view of an opening dedicated to insert a tubular ring lug ferrule into a contactor, in accordance with the disclosure.

FIG. 6 is a partial exploded view of a method of inserting a ring ferrule into a contactor, in accordance with the disclosure.

FIG. 7 is a partial view of an opening dedicated to insert a ring ferrule into a contactor, in accordance with the disclosure.

### DETAILED DESCRIPTION OF THE INVENTION

The present disclosure addresses the challenge of providing a contactor that is capable of using variety of ferrule sizes, ensuring a secure and reliable ferrule attachment. The present disclosure introduces a terminal opening cavity entry design that comprises a wide section and a narrow section, wherein the narrow section is narrower than the ferrule cavity within the terminal. These sections are specifically configured to accommodate ferrules of various sizes. The narrow section has a greater width than the pin of the largest ferrule intended for insertion. As a result, it enables the stable installation of ferrules that fit within the narrow section, as well as larger ferrules, which can be inserted through the wide section and subsequently positioned with their pin in the narrow section of the opening.

The wide section and the narrow section of the opening are advantageously arranged parallel to each other and perpendicular to the screw clamping direction. This configuration facilitates the placement of a larger ferrule onto the narrow section through simple linear movements—by inserting the ferrule into the cavity and positioning it in the narrow section of the opening. The movement is further simplified if the arrangement remains symmetrical and the placement motion follows a straight line parallel to the clamping direction of the terminal. As a result, the screwing force applied by the terminal screw enhances the secure positioning of the ferrule within the terminal.

The narrow section of the opening may be formed by one or two protrusions extending from the insulating wall. This feature allows for increased thickness of the insulating wall at a critical location for operational safety, which is very beneficial. Additionally, a shape-based locking mechanism is introduced—wherein the protrusion prevents unintentional displacement of the ferrule during the operation of the contactor. Consequently, the invention not only allows the use of multiple ferrule sizes and types within a single contactor but also enhances the overall operational safety of the device.

It is noted that in the description of the figures, same reference numerals refer to the same of similar components performing a same of essentially similar function.

For a proper understanding of the disclosure, in the detailed description below, corresponding elements or parts of different embodiments will be denoted with identical reference numerals in the drawings. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

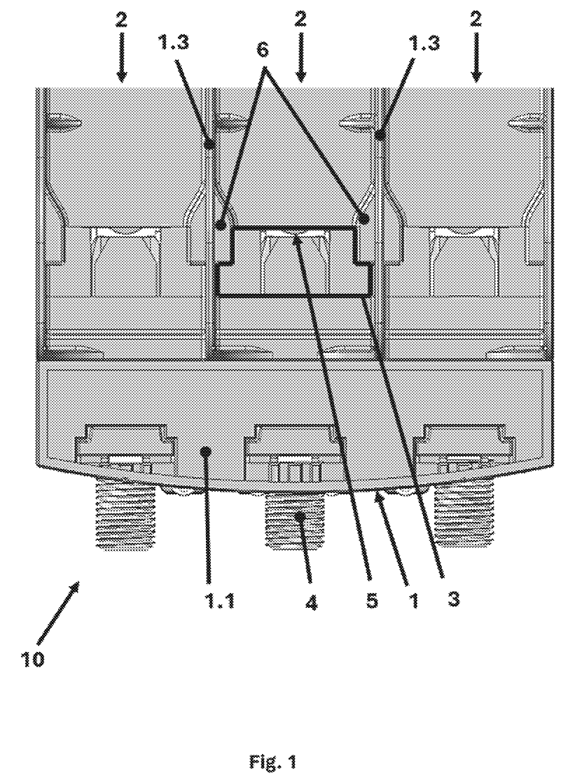

FIG. 1 depicts a contactor 10 with modular connection of the coil, comprising an insulating body 1, an operating coil (not shown) housed in the insulating body 1, and means of modular connection of the coil to an external circuit so that the coil may be powered, and three pairs of screw connecting terminals 2 configured to connecting main poles of the contactor 10. The insulation body 1 comprises a cover 1.1, and a housing 1.2 with an insulation walls 1.3. All these components are made of plastic.

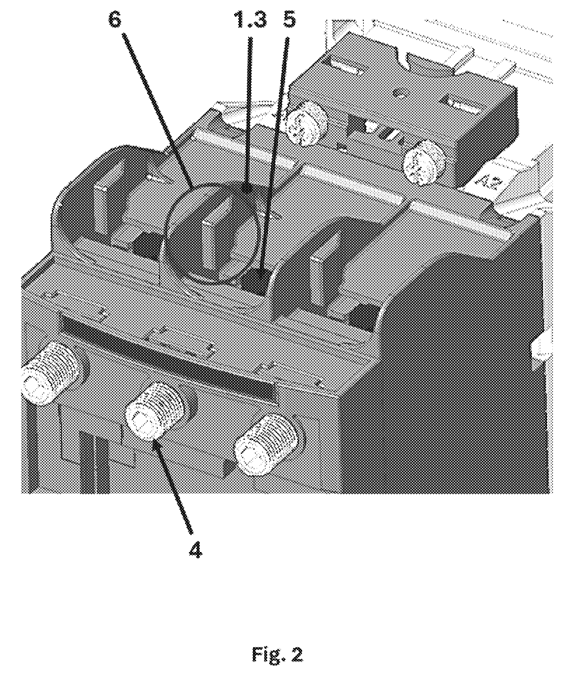

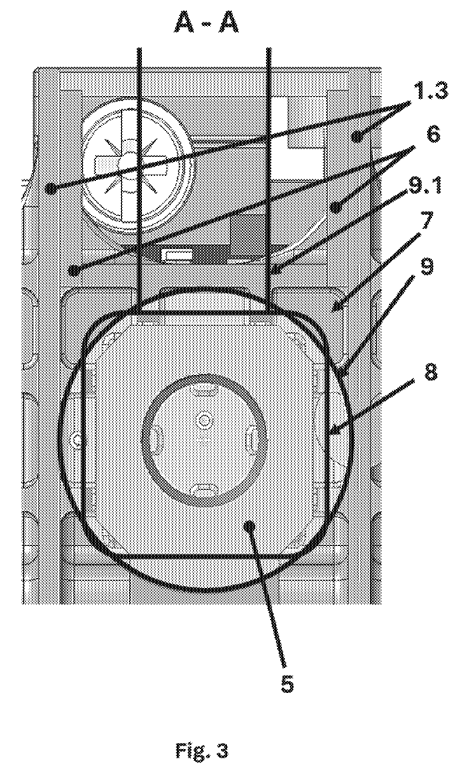

Each screw connecting terminals 2 has a fixed contact 5 in a ferrule cavity 7 (see FIG. 2 and FIG. 3), and the ferrule cavity 7 has an opening 3 between the insulation walls 1.3. The opening 3 by the narrow section 3.2 opens into the part of the ferrule cavity 7 adjacent to the fixed contact 5, while the wide section 3.1 is on the opposite side to the fixed contact 5. The ferrule cavity 7 has a width equal to the width of the wide sections 3.1. A width of the wide section 3.1 and narrow section 3.2 are mutually parallel and oriented such that they are perpendicular to a terminal screw 4 of the screw connecting terminal 2. The centres of the wide section 3.1 and the narrow section 3.2 widths are symmetrical with respect to the screw connecting terminal 2.

FIG. 3, FIG. 5 and FIG. 7 depict the opening 3 comprising a wide section 3.1 (see FIG. 7) and a narrow section 3.2 (see FIG. 5) narrower than the wide section 3.1 and the ferrule cavity 7 (see FIG. 3), such that the wide section 3.1 and the narrow section 3.2 are configured to fit with different types of ferrules - tubular ring lugs 8, round lugs 9. The narrow section 3.2 is wider than a pin 9.1 of the ferrule which size fits to the wide section 3.1 - round lug 9.

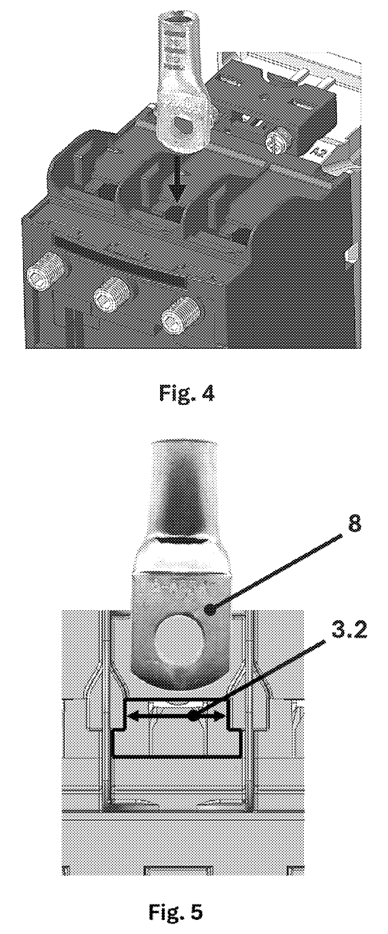

In one embodiment, the narrow section 3.2 is configured to accommodate the tubular ring lugs 8 which have widths of 13 millimetres. The narrow section 3.2 has a width that allows a direct insertion of it. FIG. 4 and FIG. 5 illustrate the direct insertion.

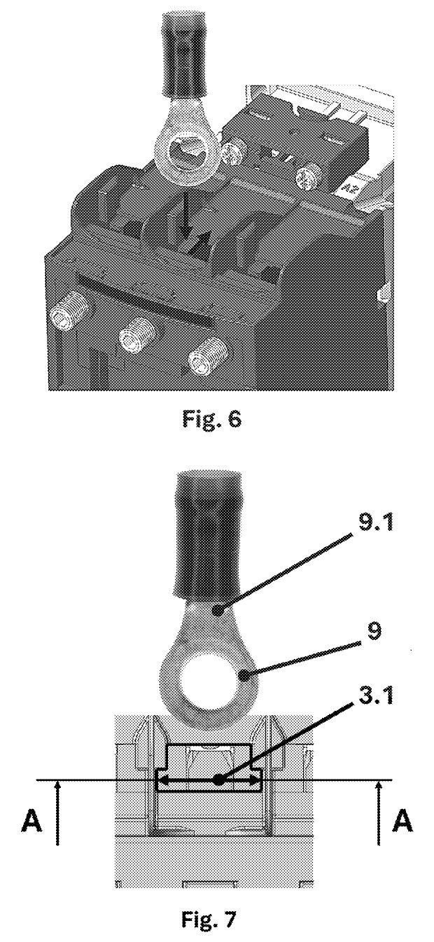

In this embodiment, the wide section 3.1 is sized to allow the direct insertion of the round lugs 9 with a width of 16 millimetres to the ferrule cavity 7. Meanwhile, the pin 9.1 of the round lug 9 is narrower than 13 millimetres, allowing it to fit within the narrow section 3.2. This design enables a two-step insertion process for the round lug 9. FIG. 6 and FIG. 7 illustrate this two-step insertion.

In other, unillustrated embodiments, the narrow section 3.2 may be configured for a tubular ring lug with a width of 13 millimetres, while the wide section 3.1 is configured for a 21-millimetre-wide round lug 9. Alternatively, the narrow section 3.2 may be sized to allow the direct insertion of a 16-millimetre-wide tubular ring lug, with the wide section 3.1 configured for the 21-millimetre-wide round lug 9. These configurations all facilitate a two-step insertion process for the round lugs 9.

FIG. 2 depicts additional protrusion 6 extending from the insulation walls 1.3 but not extending into the ferrule cavity 7. There are two mutually symmetrical protrusion 6 in the screw connecting terminal 2 arrangement. The narrow section 3.2 is formed by the additional protrusions 6. The additional protrusions 6 creates an extra insulation material, which increases the safety of use.

The ensuing description above provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A contactor with modular connection for a coil, comprising:
an insulating body;
an operating coil housed in the insulating body; and
a modular connection arrangement for the operating to an external circuit so that the coil may be powered, which modular connection arrangement comprises:
a pair of screw connecting terminals, each having a fixed contact disposed in a ferrule cavity, wherein the ferrule cavity has an opening disposed between insulation walls;
wherein the opening defines a wide section and a narrow section that is narrower than the wide section and the ferrule cavity;
wherein the wide section and the narrow section are configured to accommodate different sizes of ferrules;
wherein the narrow section is wider than a pin of a ferrule sized to fits through the wide section; and
wherein the opening adjacent the narrow section opens into a part of the ferrule cavity that is disposed adjacent to a fixed contact, while the opening adjacent the wide section is disposed opposite the fixed contact.

2. The contactor of claim 1, wherein the wide section and the narrow section are arranged in parallel to one another and are oriented such that they are perpendicular to a terminal screw of the screw connecting terminal.

3. The contactor of claim 1, wherein the wide section and the narrow are disposed symmetrically with respect to the screw connecting terminal.

4. The contactor of claim 1, wherein the ferrule cavity has a width equal to a width of the wide section.

5. The contactor of claim 1, wherein the narrow section is formed by at least one additional protrusion that extends from one of the insulation walls.

6. The contactor of claim 1, wherein the narrow section is formed by two additional protrusions extending from the insulation walls, the two additional protrusions being mutually symmetrical relative to the screw connecting terminal.
